(19) United States
(12) Patent Application Publication
(10) Pub. No.: US 2019/0047350 A1
(43) Pub. Date: Feb. 14, 2019

(54) Vibration Damper, Method For Operating A Vibration Damper, Control Device And Motor Vehicle

(71) Applicant: ZF Friedrichshafen AG, Friedrichshafen (DE)

(72) Inventors: Achim THOMAE, Bergrheinfeld (DE); Eberhard SIMON, Gochsheim (DE); Andreas FÖRSTER, Schweinfurt (DE); Steffen HEYN, Niederwerrn (DE); Helmut BAALMANN, Bergrheinfeld (DE)

(21) Appl. No.: 15/761,674

(22) PCT Filed: Sep. 6, 2016
(86) PCT No.: PCT/EP2016/070978

§ 371 Date: Mar. 20, 2018

(30) Foreign Application Priority Data
Sep. 25, 2015 (DE) 10 2015 218 494.3

(51) Int. Cl. B60G 17/08

(52) U.S. Cl. CPC B60G 17/08; B60G 2400/5182; B60G 2500/02; B60G 2500/11; B60G 2800/9123; B60G 2600/02; B60G 2600/182; B60G 2600/184; B60G 2800/162; B60G 2500/30

(57) ABSTRACT

A vibration damper with a damping force adjusting device and a height adjusting device for changing the axial position of a piston of the vibration damper, characterized in that the damping force adjusting device is adjusted depending on at least one operating parameter of the height adjusting device, and when there is a change in the at least one operating parameter there is also a change in at least one operating parameter of the damping force adjusting device. A method of operating a vibration damper with a controller and a motor vehicle including such vibration damper and controller is also disclosed.

### PRIORITY CLAIM

This is a U.S. national stage of application No. PCT/EP2016/070978, filed on Sep. 6, 2016. Priority is claimed on the following application: Country: Germany, Application No.: 10 2015 218 494.3, filed: Sep. 25, 2015, the content of which is/are incorporated herein by reference in its entirety.

### FIELD OF THE INVENTION

The present invention is directed to a vibration damper with a damping force adjusting device and a height adjusting device for changing the axial position of a piston of the vibration damper.

### BACKGROUND OF THE INVENTION

A body control of the vehicle body is carried out by the height adjusting device. As is well known, this is a matter of compensating for roll or pitch or, more broadly, implementing a level adjustment of the vehicle body. On sloping surfaces such as hillsides or with road irregularities or cornering or braking maneuvers, for example, the effects on the vehicle body can be reduced.

This function cannot be performed by conventional vibration dampers, also known as passive vibration dampers. On the contrary, an adjusting device is required by which the relative position of the piston can be actively changed from the outside by a controller. It is known to use hydraulic pumps for this purpose.

There are a number of different known systems by which body control can be carried out. For example, US 2009/0260935 A1 discloses a vibration damper which has a gerotor which is coupled to a pump. A gerotor is a device which can be operated both as motor and as generator. This gerotor pump can be used to recuperate energy and to perform body control and wheel control. Accordingly, wheel control, body control and recuperation are achieved by the same apparatus.

“Wheel control” generally means that the damping force of the vibration damper is variable; the damping force can often be adjusted in the course of a chassis adjustment. For example, different driving modes such as “comfort” and “sport” can be selected in a motor vehicle. The damping forces of the vibration dampers are adjusted correspondingly.

DE 10 2009 022 328 A1, on the other hand, shows a vibration damper in which the wheel control is carried out by a pressure control valve and the body control is carried out by a motor/pump unit. In this construction, the body control and the wheel control are realized by independent units which can accordingly be optimized separately.

In the known constructions, the adjustable valve, i.e., the damping force adjusting device, is adjusted in such a way that it goes beyond the maximum pressure that can be generated by the pump. Otherwise, there would be the risk that the valve was a leakage point for the pump.

In view of the foregoing, it is an object of the present invention to provide a vibration damper which is improved over the known art.

### SUMMARY OF THE INVENTION

To meet this object, it is provided that the damping force adjusting device is adjusted depending on at least one operating parameter of the height adjusting device, and wherein, when there is a change in the at least one operating parameter, there is also a change in at least one operating parameter of the damping force adjusting device. It will be assumed in the following for purposes of illustration that the height adjusting device is constructed as a hydraulic pump and the damping force adjusting device is constructed as an adjustable valve. However, this is exclusively for the purpose of clearer illustration; all devices performing the described functions are suitable in principle.

Accordingly, it is provided that the adjustable valve is adjusted depending on the hydraulic pump. For example, a pressure difference can be specified at which the adjustable valve should lie above the pressure instantaneously generated by the pump. This offers the advantage that the adjustable valve will still remain open when suddenly driving over an obstacle, for example, but is to be considered closed relative to the pump in normal operation. In this way, the pump or any other height adjusting device can continue to be operated at maximum efficiency while nevertheless increasing driving comfort. In conventional systems, however, driving comfort can suffer through the adjustment of a predetermined pressure at the adjustable valve that is changed exclusively based on the driver's choice as was described.

Advantageously, the damping force adjusting device can be used as a pressure limiting valve. This means, for example, that it can be arranged as a valve in the piston or as a plurality of valves in the piston. This considerably simplifies the construction of the vibration damper.

In an advantageous manner, the damping force generating device can have at least one adjustable valve, preferably two adjustable valves, which are provided for the compression stage and/or rebound stage. It is customary to use one valve for the rebound stage and one valve for the compression stage. This means that the valves are closed in one flow direction of the hydraulic medium and have an adjustable flow resistance for the other direction.

The operating parameter, or operating parameters, of the damping force adjusting device need not be changed during every such marginal change in an operating parameter of the height adjusting device; it can also be provided that changes in the operating parameters of the damping force adjusting device are changed only when a threshold value of the change in the operating parameter of the height adjusting device is exceeded or only at selected operating parameters of the height adjusting device. In other words, operating parameters of the damping force adjusting device need only be changed when changes in the height adjusting device are relevant for the damping force adjusting device.

The damping force adjusting device can advantageously have at least one valve with a variable flow resistance. For example, the valve can have an electromagnetic mechanism for this purpose so that the valve can be adjusted by changing an actuating current.

The height adjusting device can preferably comprise a hydraulic pump which is hydraulically connected to the working cylinder of the vibration damper. In principle, as has already been described above, it is known to use hydraulic pumps for height adjustment of a vibration damper and, therefore, of a motor vehicle body. Accordingly, it is also known to link the latter to a vibration damper.

As has already been described, an operating parameter of the height adjusting device is preferably a pressure generated by it. Accordingly, an operating parameter of the damping force adjusting device is an opening pressure, where the opening pressure is greater than the pressure generated by the height adjusting device. This means that the damping force adjusting device is always adjusted such that it operates so as to be closed relative to the height adjusting device. If the damping force adjusting device were arranged in the piston of the vibration damper, the height adjustment of the piston would otherwise not be controllable. For this reason, every valve located in the piston has been adjusted heretofore such that it has a higher opening pressure than the highest pressure which can be generated by the hydraulic pump.

Alternatively, an operating parameter of the damping force adjusting device can be an opening pressure and the opening pressure can be greater than the pressure generated by the height adjusting device.

As a further alternative, an operating parameter of the damping force adjusting device can be an opening pressure, and the opening pressure is less than the pressure generated by the height adjusting device. While this results in a continuous leak, this leakage can be minimized because of the adaptation of the opening pressure. A particularly comfort-friendly damping is achieved in this way.

The damping force adjusting device and the height adjusting device can preferably be connected in parallel. This results when the damping force adjusting device is embedded in the piston. As a result of the parallel connection of the damping force adjusting device and the height adjusting device, the oil volume flow is distributed corresponding to the ratio of the flow resistance of the damping force adjusting device and the height adjusting device to the total resistance given by the sum of the two flow resistances.

The invention is additionally directed to a method for operating a vibration damper with a damping force adjusting device and a height adjusting device. This is characterized in that the damping force adjusting device is operated depending on at least one operating parameter of the height adjusting device.

Advantageous configurations of the method follow in principle from the described vibration damper, and the relevant description is therefore referred to.

One more point to be addressed again is that the damping force device can be adjusted in such a way that it is closed or acts closed relative to the height adjusting device. This results when the pressure generated by the height adjusting device is not sufficient to change the behavior of the damping force adjusting device; that is, this pressure is not sufficient for pushing hydraulic medium through the damping force adjusting device. This additional pressure is generated, for example, when driving over an obstacle, so that the damping force adjusting device opens in this driving situation and a hard impact is not transmitted to the vehicle body by driving over an obstacle.

The adjustment of the damping force adjusting device can advantageously be carried out with a time delay. The change in an operating parameter of the height adjusting device can be reflected in a pressure difference only after a time delay, and time delays in the damping force adjusting device, insofar there are any at all, are usually shorter than in the height adjusting device. Accordingly, the changes in the operating parameters of the damping force adjusting device and of the height adjusting device can be synchronized to implement a time offset.

A sensor can preferably be used to sense the at least one operating parameter of the height adjusting device. For example, electric motors usually have sensors which sense the position of the electric motor. This information can be used as operating parameter of the height adjusting device.

The invention is additionally directed to a controller for a motor vehicle. This is characterized in that the controller is constructed to implement the method as has been described. The controller may, for example, be formed of a computer, including a central processing unit, a memory, an external storage device, an input/output device and the like.

The invention is additionally directed to a motor vehicle with at least one vibration damper and a controller. The motor vehicle is characterized in that the vibration damper is constructed as described above and/or the controller is constructed as described above.

### BRIEF DESCRIPTION OF THE DRAWINGS

Further advantages, features and details of the invention will emerge from the following description of embodiment examples and drawings in which:

FIG. 1 is a hydraulic schematic of a vibration damper of the present invention;

FIG. 2 is an embodiment of a vibration damper of the present invention; and

FIG. 3 is a flow chart for the operation of a vibration damper of the present invention, and

FIG. 4 is a schematic view of a vehicle and controller for practicing the present invention.

### DETAILED DESCRIPTION OF THE PRESENTLY PREFERRED EMBODIMENTS

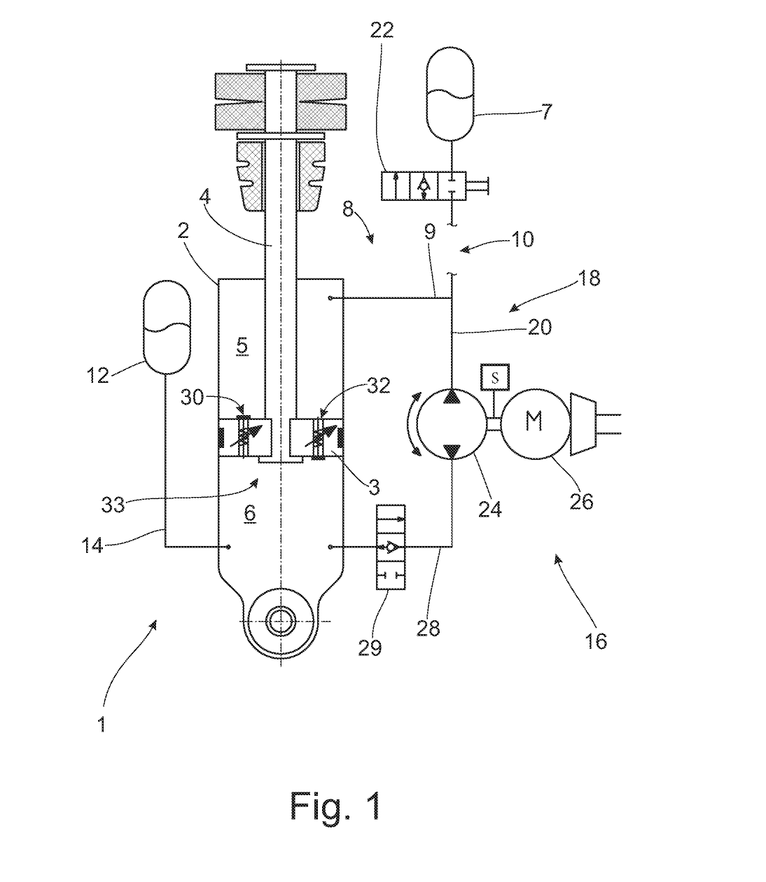

FIG. 1 shows a vibration damper 1 with a working cylinder 2, a piston 3 and a piston rod 4 which is fastened to the piston 3. Piston 3 divides the working cylinder into a first working chamber 5 and a second working chamber 6. The first storage device 7 for hydraulic fluid or oil is connected to the first working chamber 5 via a first fluid path 8. The first fluid path 8 has portions 9 and 10.

A second storage device 12 for hydraulic fluid or oil is connected to the second working chamber 6 via a second fluid path 14. A hydraulic device 16, as height adjusting device, is connected to the first working chamber 5 via a third fluid path 18 comprising portions 9 and 20. Accordingly, the first fluid path 8 and the third fluid path 18 partially coincide, namely, in portion 9.

The second storage device 12 serves as compensation chamber to compensate for the oil volume displaced when the piston rod moves in. The first storage device 7, on the other hand, is a reservoir which is accessed by the hydraulic device 16 to regulate the level of the piston 3 and, therefore, of the motor vehicle body.

A valve 22 is arranged as closing device in the first fluid path 8. As is shown, the valve can be open in both flow directions; it can also open in one flow direction and close in the other flow direction depending upon setting. Further, the valve 22 can block the first fluid path 8 only partially so that the flow is merely impeded but is not entirely blocked. However, a complete closure of the first fluid path 8 is preferably provided so that the vibration damper 1 operates as though the first storage device 7 were absent.

The hydraulic device 16 includes a pump 24 and a motor 26. The motor 26 is the driving device of the pump 24. A sensor S is preferably used to sense at least one operating parameter of the height adjusting device.

The hydraulic device 16 is connected to the second working chamber 6 via a fourth fluid path 28. If the valve 22 is arranged in portion 9 rather than in portion 10 of the first flow path 8 and a further valve 29 is provided in the fourth fluid path 28 (as indicated in FIG. 1), the hydraulic device 16 can also be disconnected from the vibration damper 1 and working cylinder 2, respectively.

The vibration damper 1 then works as if there were no hydraulic device 16 and no first storage device 7.

In addition to adjusting the body control, an adjustment of the wheel control can also be provided. This means that the damping force of the vibration damper can be varied. To this end, for example, two valves 30 and 32 can be provided in piston 3, and the flow resistance of the piston can be adjusted in rebound direction and compression direction by the two valves 30 and 32. Valves 30 and 32 can also be arranged outside of working cylinder 2. For example, they can be located in a unit at the receptacle tube of the vibration damper 1. The second fluid path 14 is preferably always open because closure could lead to damage to the vibration damper. If the fourth fluid path 28 and the second fluid path 14 share common portions, a valve for closing the fourth fluid path is provided in a portion which does not correspond to the second fluid path 14.

Fluid paths 8, 14, 18 and 28 are preferably guided inside a receptacle tube of the vibration damper 1. Only one portion through the pump 24 can run outside of the receptacle tube. This can obviate the use of hoses. A two-tube damper construction with an intermediate tube can be used to form the fluid paths so that three parallel fluid paths can be realized.

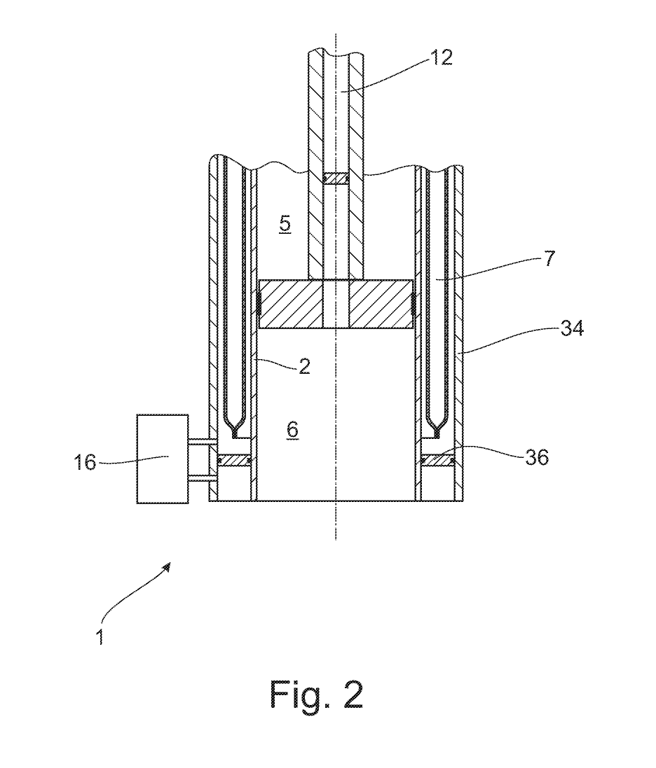

FIG. 2 shows a first embodiment of a vibration damper 1 in which the second storage device 12 is constructed as a piston storage and the first storage device 7 is constructed as a gas bag. In order to guide the fluid, particularly hydraulic oil, outside of the working cylinder 2, a receptacle tube 34 is provided which encloses the working cylinder 2. A dividing piston 36 is located in the vicinity of the base of the receptacle tube 34 so that the fluid is guided through the hydraulic device 16. This hydraulic device can be constructed in the manner described above.

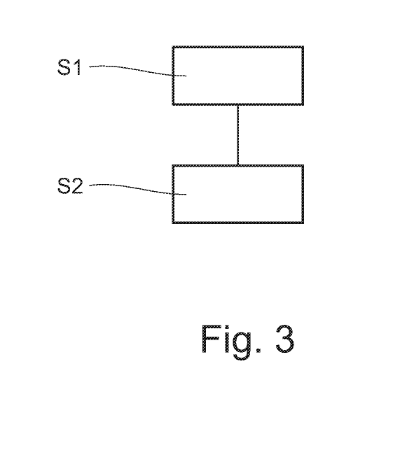

FIG. 3 shows a flow chart for the operation of the vibration damper 1. In step S1, the motor 26 receives a signal for carrying out a predetermined movement. Concurrently or after a time offset, valve 30 and/or 32 of the damping force adjusting device 33 is controlled in step S2 such that the pressure drop across valves 30 and 32 is higher by a predetermined value than the pressure generated in working cylinder 2 by pump 24. Valves 30 and 32 can be adjusted differently because different pressures can also be present in working chambers 5 and 6. In this way, an adjustment of valves 30 and 32 can be achieved for the compression stage as well as for the rebound stage in which the desired body control is carried out and an overpressure is simultaneously prevented when driving over obstacles.

The implementation of the method in accordance with the flow chart in FIG. 3 is not restricted to the specific embodiment of the damping force adjusting device 33 or the height adjusting device according to FIGS. 1 and 2. This is merely a preferred embodiment example with which the method according to FIG. 3 can be carried out.

A time delay for carrying out steps S1 and S2 and, therefore, for sending the signal can result in that the generation of a pressure is carried out through the pump 24 in a time-delayed manner after the signal is sent, or has longer time offset than the pressure adjustment of the valve 30 or 32. Time delays of this type can be quantified so that it is also possible to carry out step S2 at a predetermined time after step 21. It is also possible in principle to carry out step S2 before step S1. However, this is only necessary when the adjustment of the valves 30 and/or 32 has a longer time delay than the pressure changes generated by pump 24.

It will be noted that the damping force adjusting device 33 and the height adjusting device comprising pump 24 and motor 26 are connected in parallel in the vibration damper shown in FIGS. 1 and 2. This results from the fact that an oil volume flow brought about, e.g., by a movement of the piston rod, can flow in parallel through both the damping force adjusting device and the height adjusting device.

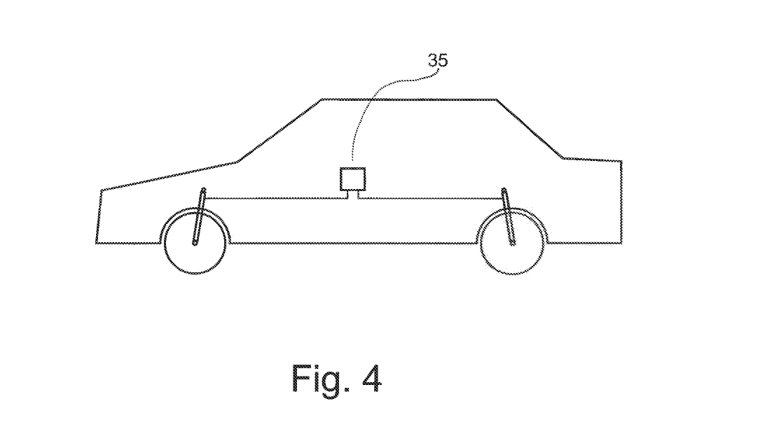

FIG. 4 schematically shows a vehicle including a controller 35 for practicing the method of the present invention. In addition to the controller the vehicle has at least one vibration damper as above described.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed:

1-16. (canceled)

17. A vibration damper comprising:
a damping force adjusting device and a height adjusting device for changing the axial position of a piston of the vibration damper, the damping force adjusting device and the height adjusting device constructed to be operated by at last one operating parameter;
the damping force adjusting device constructed to be adjusted depending on the at least one operating parameter of the height adjusting device, and wherein, when there is a change in the at least one operating parameter of the height adjusted device, there is also a change in the at least one operating parameter of the damping force adjusting device.

18. The vibration damper according to claim 17, wherein the damping force adjusting device comprises at least one valve with a variable flow resistance.

19. The vibration damper according to claim 17, additionally comprising a working cylinder, and wherein the height adjusting device comprises a hydraulic pump which is hydraulically connected to the working cylinder of the vibration damper.

20. The vibration damper according to claim 17, wherein the at least one operating parameter of the height adjusting device is a pressure generated by the height adjusting device.

21. The vibration damper according to claim 20, wherein the at least one operating parameter of the damping force adjusting device is an opening pressure, and whereby the opening pressure is greater than the pressure generated by the height adjusting device.

22. The vibration damper according to claim 20, wherein the at least one operating parameter of the damping force adjusting device is an opening pressure, and wherein the opening pressure is less than the pressure generated by the height adjusting device.

23. The vibration damper according to claim 20, wherein the at least one operating parameter of the damping force adjusting device is a pressure drop brought about through the damping force adjusting device, and wherein the pressure drop is not higher than the pressure generated by the height adjusting device.

24. The vibration damper according to claim 17, wherein the damping force adjusting device and the height adjusting device are connected in parallel.

25. A method of operating a vibration damper with a damping force adjusting device and a height adjusting device, comprising operating the damping force adjusting device depending on at least one operating parameter of the height adjusting device.

26. The method according to claim 25, comprising the step of taking into account a pressure generated by the height adjusting device as an operating parameter of the height adjusting device.

27. The method according to claim 25, adjusting the damping force adjusting device in such a way that the damping force adjusting device is closed relative to the height adjusting device.

28. The method according to claim 25, wherein the adjustment of the damping force adjusting device is carried out with a time offset with respect to the height adjusting device.

29. The method according to claim 28, wherein the adjustment of the damping force adjusting device is carried out with a time delay.

30. The method according to one of claim 25, comprising the step of using a sensor to sense the operating parameter of the height adjusting device.

31. A controller for a motor vehicle, wherein the controller is constructed to implement the method of claim 25.

32. A motor vehicle comprising at least one vibration damper and a controller, wherein the vibration damper comprises a damping force adjusting device and a height adjusting device for changing the axial position of a piston of the vibration damper, the damping force adjusting device and the height adjusting device constructed to be operated by at last one operating parameter; the damping force adjusting device constructed to be adjusted depending on the at least one operating parameter of the height adjusting device, and wherein, when there is a change in the at least one operating parameter of the height adjusted device, there is also a change in the at least one operating parameter of the damping force adjusting device.

33. A motor vehicle comprising at least one vibration damper including a damping force adjusting device and a height adjusting device, the damping force adjusting device and the height adjusting device constructed to be operated by the at least one operating parameter, and a controller and wherein the controller is constructed to implement the method of claim 25.
